(19) United States
(12) Patent Application Publication
(10) Pub. No.: US 2017/0034317 A1
(43) Pub. Date: Feb. 2, 2017

(54) METHODS AND ARRANGEMENTS TO EXTEND OPERATIONAL BANDWIDTH

(71) Applicants: Thomas J. Kenney, Portland, OR (US); Eldad Perahia, Portland, OR (US); Shahrnaz Azizi, Cupertino, CA (US)

(72) Inventors: Thomas J. Kenney, Portland, OR (US); Eldad Perahia, Portland, OR (US); Shahrnaz Azizi, Cupertino, CA (US)

(73) Assignee: Intel IP Corporation, Santa Clara, CA (US)

(21) Appl. No.: 15/106,277

(22) PCT Filed: Dec. 28, 2013
(86) PCT No.: PCT/US2013/078160

§ 371 Date: Jun. 17, 2016

(51) Int. Cl. H04L 29/06; H04W 72/04

(52) U.S. Cl. CPC H04L 69/22; H04W 72/044; H04W 84/12

(57) ABSTRACT

Logic may parse a data stream into two or more 80 megahertz or 160 megahertz bandwidth frequency segments. Logic may parse a data stream into two or more frequency segments having a total bandwidth of greater than 160 megahertz. Logic may deparse the data stream prior to transmitting the data stream to transmit a communication with a contiguous bandwidth of greater than 160 megahertz. Logic may deparse the data stream prior to space-time block coding of the data stream. Logic may transmit the data stream in two or more frequency segments having a total bandwidth of greater than 160 megahertz. Logic may receive a communication with a contiguous bandwidth or two or more frequency segments with contiguous or non-contiguous bandwidths. Logic may parse a communication with a contiguous bandwidth into two or more frequency segments. And logic may deparse the frequency segments to decode the communication.

### TECHNICAL FIELD

Embodiments are in the field of wireless communications. More particularly, embodiments may involve implementing frequency segments to extend the bandwidth of a communication.

### BACKGROUND

A wireless communications system may utilize bi-directional signaling of control information to coordinate operations between geographically disparate communications devices. As a way to further evolve Wi-Fi (wireless fidelity) communications, there has been activity to make new frequency bands available in which Wi-Fi can be deployed. Two such bands include additional bandwidth in the 5 GHz band and 6-10 GHz bands. The Federal Communications Commission (FCC) announced this band was available for ultra-wideband use in 2002. The attractiveness to the band is that there is 3 GHz of contiguous bandwidth available globally. Other systems have attempted to use the band that withdrew or has had minimal market deployment. Thus, the spectrum is currently underutilized.

### BRIEF DESCRIPTION OF THE DRAWINGS

FIG. 1 depicts an embodiment of a wireless network comprising a plurality of communications devices, including multiple fixed or mobile communications devices;

FIG. 2A depicts an embodiment of an apparatus to generate, transmit, receive, decode, and interpret an extended bandwidth communications;

FIG. 2B depicts an embodiment of a 480 MHz contiguous bandwidth transmitter such as the transmitter in FIG. 2A;

FIG. 2C depicts an embodiment of a 480 MHz non-contiguous or contiguous bandwidth transmitter such as the transmitter in FIG. 2A;

FIGS. 3A-B depict embodiments of flowcharts to transmit a physical layer frame and to decode a physical layer frame; and

FIGS. 4A-B depict embodiments of flowcharts to transmit, receive, decode, and interpret communications with frames as illustrated in FIGS. 1-2.

### DETAILED DESCRIPTION OF EMBODIMENTS

The following is a detailed description of novel embodiments depicted in the accompanying drawings. However, the amount of detail offered is not intended to limit anticipated variations of the described embodiments; on the contrary, the claims and detailed description are to cover all modifications, equivalents, and alternatives falling within the spirit and scope of the present teachings as defined by the appended claims. The detailed descriptions below are designed to make such embodiments understandable to a person having ordinary skill in the art.

References to “one embodiment,” “an embodiment,” “example embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Embodiments may increase the operational bandwidth of Wi-Fi (Wireless Fidelity) communications. Some embodiments focus on 240 MegaHertz (MHz) and 320 MHz bandwidths in 5 GigaHertz (GHz). Several embodiments focus on a 480 MHz or larger bandwidths in 6-10 GHz. Many embodiments focus on other bandwidths in the same or other frequency bands. However, the embodiments are not limited to the bandwidths and frequency bands described herein.

To meet the requirements in each of the 5 GHz and 6 GHz to 10 GHz bands, some embodiments implement 80 MHz or 160 MHz bandwidth specifications of IEEE 802.11ac as frequency segments. In several embodiments, these frequency segments are used as building blocks to generate large bandwidth transmissions in multiples of 80 MHz and/or 160 MHz. The 80 MHz or 160 MHz frequency segment may comprise the same subcarrier structure as the corresponding IEEE 802.11ac bandwidths. For example, in the 160 MHz bandwidth frequency segment, there are a total of 468 data subcarriers and 16 pilot subcarriers specified in IEEE 802.11ac. Thus in this example with three—160 MHz subbands to create a contiguous 480 MHz bandwidth communication, there are a total of 1404 data subcarriers in addition to 48 pilot subcarriers.

For some embodiments that implement a contiguous bandwidth, the subcarriers may be mapped to each of the three 160 MHz bands (for a total of 480 MHz) using a mapping function to a discrete Fourier transform module. Other embodiments may use 80 MHz frequency segments as the primary building block, or a mix of both 160 MHz and 80 MHz bandwidth frequency segments to create a larger bandwidth.

Many embodiments transmit communications with an extended bandwidth by parsing a data stream into two or more 80 MHz or 160 MHz bandwidth frequency segments. Some embodiments may deparse the data stream prior to transmitting the data stream to transmit a communication with a contiguous bandwidth of greater than 160 MHz. Further embodiments may deparse the data stream prior to space-time block coding of the data stream. And other embodiments may transmit the data stream in two or more frequency segments having a total bandwidth of greater than 160 MHz.

Several embodiments may receive a communication with a contiguous bandwidth or two or more frequency segments with contiguous or non-contiguous bandwidths. In some embodiments, the frequency segments comprise two or more 80 MHz or 160 MHz bandwidth frequency segments. In some embodiments, the receiver may parse a communication with a contiguous bandwidth into two or more frequency segments to demodulate and deinterleave the frequency segments. And further embodiments may deparse or combine the frequency segments prior to decoding the communication.

Various embodiments may be designed to address different technical problems associated with transmitting or receiving communications with an extended bandwidth that comprises, e.g., greater than 160 MHz bandwidth in, e.g., 5 GHz or 6 GHz to 10 GHz frequency bands. Other technical problems may include generating a communication with a contiguous bandwidth of greater than 160 MHz, generating a communication with a non-contiguous bandwidth of greater than 160 MHz, generating two or more frequency segments, parsing a data stream to generate two or more frequency segments, deparsing two or more frequency segments, and/or the like.

Different technical problems such as those discussed above may be addressed by one or more different embodiments. For instance, some embodiments that address transmitting or receiving communications with an extended bandwidth that comprises, e.g., greater than 160 MHz bandwidth in 5 GHz or 6 GHz to 10 GHz frequency bands may do so by one or more different technical means such as generating a communication with a contiguous bandwidth based upon two or more frequency segments of 80 MHz or 160 MHz, generating a communication with a non-contiguous bandwidth based upon two or more frequency segments of 80 MHz or 160 MHz, parsing a data stream to generate two or more frequency segments, deparsing two or more frequency segments.

Some embodiments implement Institute of Electrical and Electronic Engineers (IEEE) 802.11 systems such as IEEE 802.11ah systems and other systems that operate in accordance with standards such as the IEEE 802.11-2012, IEEE Standard for Information technology—Telecommunications and information exchange between systems—Local and metropolitan area networks—Specific requirements—Part 11: Wireless LAN Medium Access Control (MAC) and Physical Layer (PHY) Specifications (http://standards.ieee.org/getieee802/download/802.11-2012.pdf).

Some embodiments are particularly directed to improvements for wireless local area network (WLAN), such as a WLAN implementing one or more Institute of Electrical and Electronics Engineers (IEEE) 802.11 standards (sometimes collectively referred to as “Wi-Fi”, or wireless fidelity). In one embodiment, for example, an improved acknowledgement scheme may be implemented for a WLAN such as the IEEE 802.11ah wireless communications standard. The embodiments, however, are not limited to this example.

Several embodiments comprise access points (APs) for and/or client devices of APs or stations (STAs) such as routers, switches, servers, workstations, netbooks, mobile devices (Laptop, Smart Phone, Tablet, and the like), as well as sensors, meters, controls, instruments, monitors, appliances, and the like. Some embodiments may provide, e.g., indoor and/or outdoor “smart” grid and sensor services.

Logic, modules, devices, and interfaces herein described may perform functions that may be implemented in hardware and/or code. Hardware and/or code may comprise software, firmware, microcode, processors, state machines, chipsets, or combinations thereof designed to accomplish the functionality.

Embodiments may facilitate wireless communications. Some embodiments may comprise low power wireless communications like Bluetooth®, wireless local area networks (WLANs), wireless metropolitan area networks (WMANs), wireless personal area networks (WPAN), cellular networks, communications in networks, messaging systems, and smart-devices to facilitate interaction between such devices. Furthermore, some wireless embodiments may incorporate a single antenna while other embodiments may employ multiple antennas. The one or more antennas may couple with a processor and a radio to transmit and/or receive radio waves. For instance, multiple-input and multiple-output (MIMO) is the use of radio channels carrying signals via multiple antennas at both the transmitter and receiver to improve communication performance.

This disclosure is not limited to WLAN related standards, but may also apply to wireless wide area networks (WWANs) and 3G or 4G wireless standards (including progenies and variants) related to wireless devices, user equipment or network equipment included in WWANs. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The examples are not limited in this context.

While some of the specific embodiments described below will reference the embodiments with specific configurations, those of skill in the art will realize that embodiments of the present disclosure may advantageously be implemented with other configurations with similar issues or problems.

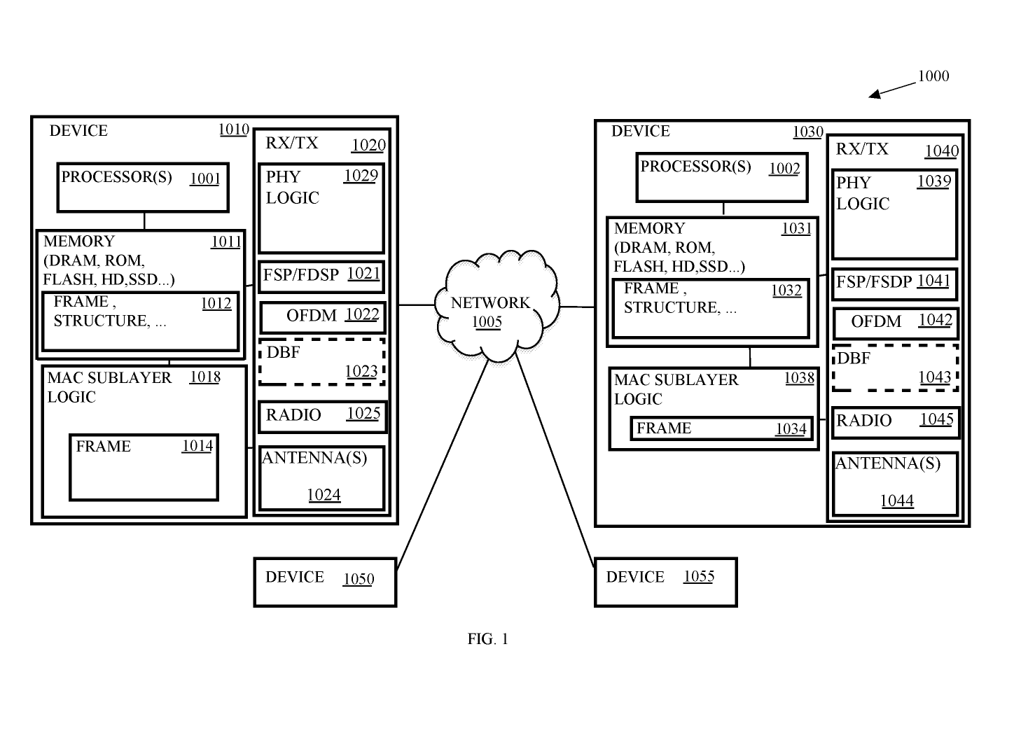

Turning now to FIG. 1, there is shown an embodiment of a wireless communication system 1000. The wireless communication system 1000 comprises a communications device 1010 that may be wire line and wirelessly connected to a network 1005. The communications device 1010 may communicate wirelessly with a plurality of communication devices 1030, 1050, and 1055 via the network 1005. The communications device 1010 may comprise a station such as a computer, laptop, netbook, smart phone, PDA (Personal Digital Assistant), or other wireless-capable device. The communications device 1030 may comprise a low power communications device such as a consumer electronics device, a personal mobile device, or the like. And communications devices 1050 and 1055 may comprise sensors, stations, access points, hubs, switches, routers, computers, laptops, netbooks, cellular phones, smart phones, PDAs, or other wireless-capable devices. Thus, communications devices may be mobile or fixed.

Initially, the communications device 1030 may determine a frame 1034 to transmit. In some embodiments, the communications device 1030 may receive a data packet and determine to respond with an, e.g., null data packet acknowledgement, and, in other embodiments, the communications device 1030 may determine to contact the communications device 1010 with a probe request, an association request, or the like. The medium access control (MAC) sublayer logic 1038 may communicate with the physical layer (PHY) logic 1039 to transmit the frame 1034 or may provide a MAC frame to the PHY logic 1039 to transmit to the communications device 1010. In many embodiments, the PHY logic 1039 may generate a preamble to prepend to the frame prior to transmitting the MAC frame 1034.

After instructing the PHY logic 1039 to transmit the frame 1034, the PHY logic 1039 may prepare the frame 1034 by, e.g., determining a preamble including a short training field (STF) value, a long training field (LTF) value, and a signal (SIG) field value to transmit as part of a PHY frame. The PHY layer device such as the transmitter of the transceiver (RX/TX) 1040 may then begin processing the PHY frame to transmit to the communications device 1010.

In several embodiments, the PHY frame may be transmitted from module to module through the transmitter of the transceiver (RX/TX) 1040 as a data stream to process the PHY frame in preparation for transmission to the communications device 1010. In many embodiments, after encoding the PHY frame, the communications device 1030 may comprise a frequency segment parser/frequency segment deparser (FSP/FSDP) 1021 to parse the encoded PHY frame into two or more frequency segments. In some embodiments, the frequency segment parser may reside in the transmitter and the frequency segment deparser may reside in the receiver. In further embodiments, the frequency segment parser and deparser may reside in both transmitter and the receiver. For instance, in one embodiment, the frequency segment parser may parse or divide the PHY frame into six frequency segments of 80 MHz bandwidths. An interleaver and a constellation mapper in each branch of the six frequency segments may process each of the six data streams. In some embodiments, such as embodiments designed for non-contiguous bandwidths, the six frequency segments may be processed and transmitted as six different frequency segments with the overall bandwidth of 480 MHz. In several embodiments, the bandwidths may be contiguous or non-contiguous.

In other embodiments that are designed to transmit contiguous bandwidths, the six frequency segments may be deparsed or combined into a single data stream prior to transmission of the 480 MHz bandwidth signal. In some embodiments, the six frequency segments may be deparsed after mapping the data streams to constellations (subcarrier modulation mapping or “modulation”) by a constellation mapper and/or deparsed prior to space-time block coding of the data stream. Thereafter, in such embodiments, the data stream may be processed as a single data stream and transmitted as a contiguous, 480 MHz signal.

Note that most of the discussions herein may describe and illustrate a single spatial stream transmission. Many embodiments are capable of multiple spatial stream transmissions and utilize parallel data processing paths from the PHY logic 1039 through to transmission.

After the transmitter transmits the 480 MHz bandwidth signal, a receiver may detect and receive the signal. In many embodiments, a receiver of the communications device 1010 may receive the signal as a non-contiguous bandwidth or a contiguous bandwidth, depending upon the protocol or the design of the communications devices 1010 and 1030. For the case in which the communications device 1030 transmits the PHY frame as six separate contiguous or non-contiguous 80 MHz bandwidth signals, the communications device 1010 may comprise a transceiver (RX/TX) 1020 with a receiver to receive the stream as six separate contiguous or non-contiguous signals. In many of these embodiments, the transceiver 1020 comprises FSP/FDSP 1021 to deparse the six signals prior to decoding the six signals.

For the case in which the communications device 1030 transmits the PHY frame as a single contiguous 480 MHz bandwidth signal, the transceiver (RX/TX) 1020 may receive the stream as one contiguous 480 MHz bandwidth signal. In several of these embodiments, the transceiver 1020 comprises FSP/FDSP 1021 to parse the signal into six separate signals prior to demodulation (also referred to as constellation demapping or subcarrier modulation demapping) and deinterleaving the signal. In such embodiments, the FSP/FDSP 1021 may deparse the six signals to a single signal prior to decoding the signal.

The network 1005 may represent an interconnection of a number of networks. For instance, the network 1005 may couple with a wide area network such as the Internet or an intranet and may interconnect local devices wired or wirelessly interconnected via one or more hubs, routers, or switches. In the present embodiment, the network 1005 communicatively couples communications devices 1010, 1030, 1050, and 1055.

The communication devices 1010 and 1030 comprise processor(s) 1001 and 1002, memory 1011 and 1031, and MAC sublayer logic 1018 and 1038, respectively. The processor(s) 1001 and 1002 may comprise any data processing device such as a microprocessor, a microcontroller, a state machine, and/or the like, and may execute instructions or code in the memory 1011 and 1031. The memory 1011 and 1031 may comprise a storage medium such as Dynamic Random Access Memory (DRAM), read only memory (ROM), buffers, registers, cache, flash memory, hard disk drives, solid-state drives, or the like. The memory 1011 and 1031 may be coupled with the MAC sublayer logic 1018, 1038 and/or may be coupled with the PHY device, transceiver 1040. In many embodiments, the memory 1011 and 1031 may store the frames and/or the frame structures, and the memory 1011 and 1031 may store frame headers or portions thereof. In many embodiments, the frames may comprise fields based upon the structure of the standard frame structures identified in IEEE 802.11.

The MAC sublayer logic 1018, 1038 may comprise logic to implement functionality of the MAC sublayer of the data link layer of the communications device 1010, 1030. The MAC sublayer logic 1018, 1038 may generate the frames such as management frames, data frames, and control frames, and may communicate with the PHY logic 1029, 1039. The PHY logic 1029, 1039 may generate physical layer protocol data units (PPDUs) based upon the frames 1014, 1034. More specifically, the frame builders may generate frames 1014, 1034 and the data unit builders of the PHY logic 1029, 1039 may prepend the frames 1014, 1034 with preambles to generate PPDUs for transmission via a physical layer (PHY) device such as the transceivers (RX/TX) 1020 and 1040.

The frame 1014, also referred to as MAC layer Service Data Units (MSDUs), may comprise, e.g., a management frame. For example, a frame builder may generate a management frame such as the beacon frame to identify the communications device 1010 as having capabilities such as supported data rates, power saving features, cross-support, and a service set identification (SSID) of the network to identify the network to the communications device 1030. The MAC sublayer logic 1018 may pass the frame to the PHY logic 1029 and the PHY logic 1029 may prepend a preamble to generate a PHY frame prior to transmitting the PHY frame.

The communications devices 1010, 1030, 1050, and 1055 may each comprise a transmitters and receivers such as transceivers (RX/TX) 1020 and 1040. In many embodiments, transceivers 1020 and 1040 implement orthogonal frequency-division multiplexing (OFDM) 1022, 1042. OFDM 1022, 1042 implements a method of encoding digital data on multiple carrier frequencies. OFDM 1022, 1042 comprises a frequency-division multiplexing scheme used as a digital multi-carrier modulation method. A large number of closely spaced orthogonal subcarrier signals are used to carry data. The data is divided into several parallel data streams or channels, one for each subcarrier. Each subcarrier is modulated with a modulation scheme at a low symbol rate, maintaining total data rates similar to conventional single-carrier modulation schemes in the same bandwidth.

An OFDM system uses several carriers, or “tones,” for functions including data, pilot, guard, and nulling. Data tones are used to transfer information between the transmitter and receiver via one of the channels. Pilot tones are used to maintain the channels, and may provide information about time/frequency and channel tracking. And guard tones may help the signal conform to a spectral mask. The nulling of the direct component (DC) may be used to simplify direct conversion receiver designs. And guard intervals may be inserted between symbols such as between every OFDM symbol as well as between the short training field (STF) and long training field (LTF) symbols in the front end of the transmitter during transmission to avoid inter-symbol interference (ISI), which might result from multi-path distortion.

Each transceiver 1020, 1040 comprises a radio 1025, 1045 comprising an RF transmitter and an RF receiver. The RF transmitter comprises an OFDM 1022, which impresses digital data, OFDM symbols encoded with tones, onto RF frequencies, also referred to as subcarriers, for transmission of the data by electromagnetic radiation. In the present embodiment, the OFDM 1022 may impress the digital data as OFDM symbols encoded with tones onto the subcarriers to for transmission. The OFDM 1022 may transform information signals into signals to be applied via the radio 1025, 1045 to elements of an antenna array 1024. An RF receiver receives electromagnetic energy at an RF frequency and extracts the digital data from the OFDM symbols.

In some embodiments, the communications device 1010 optionally comprises a Digital Beam Former (DBF) 1023, as indicated by the dashed lines. In some embodiments, the DBF 1023 may be part of the OFDM 1022. The DBF 1023 provides spatial filtering and is a signal processing technique used with antenna array 1024 for directional signal transmission or reception. This is achieved by combining elements in a phased antenna array 1024 in such a way that signals at particular angles experience constructive interference while others experience destructive interference. Beamforming can be used at both the transmitting and receiving ends in order to achieve spatial selectivity. The antenna array 1024 is an array of individual, separately excitable antenna elements. The signals applied to the elements of the antenna array 1024 cause the antenna array 1024 to radiate one to four spatial channels. Each spatial channel so formed may carry information to one or more of the communications devices 1030, 1050, and 1055. Similarly, the communications device 1030 comprises the transceiver (RX/TX) 1040 to receive and transmit signals from and to the communications device 1010. The transceiver (RX/TX) 1040 may comprise an antenna array 1044 and, optionally, a DBF 1043.

FIG. 1 may depict a number of different embodiments including a Multiple-Input, Multiple-Output (MIMO) system with, e.g., four spatial streams, and may depict degenerate systems in which one or more of the communications devices 1010, 1030, 1050, and 1055 comprise a receiver and/or a transmitter with a single antenna including a Single-Input, Single Output (SISO) system, a Single-Input, Multiple Output (SIMO) system, and a Multiple-Input, Single Output (MISO) system. In the alternative, FIG. 1 may depict transceivers that include multiple antennas and that may be capable of multiple-user MIMO (MU-MIMO) operation.

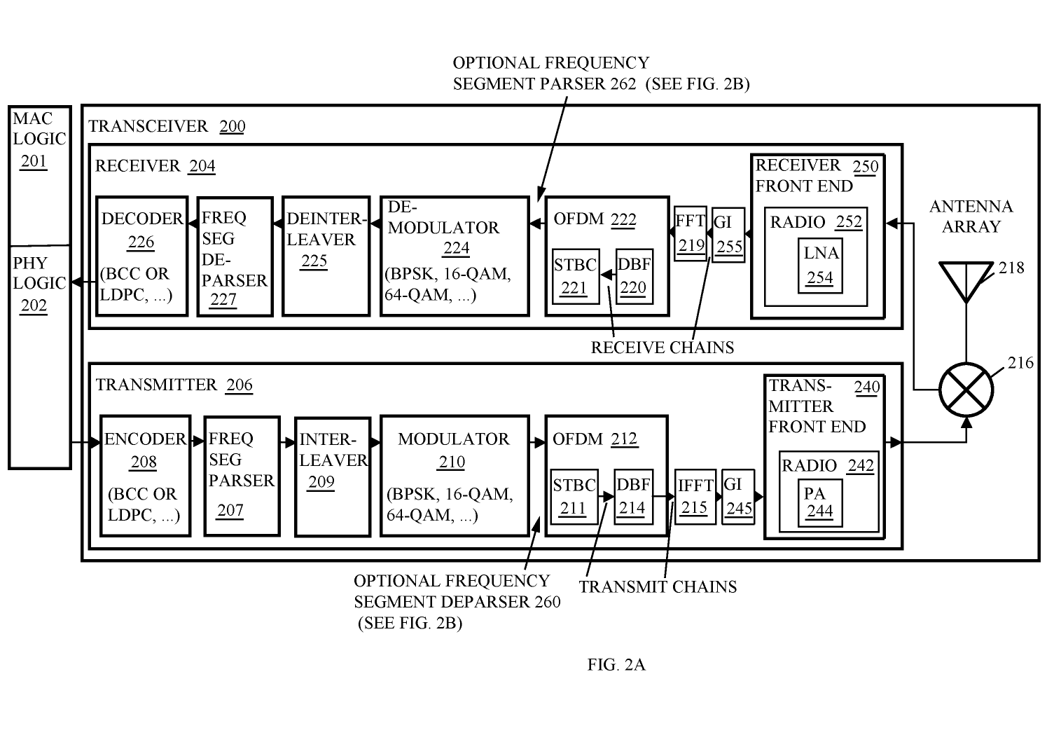

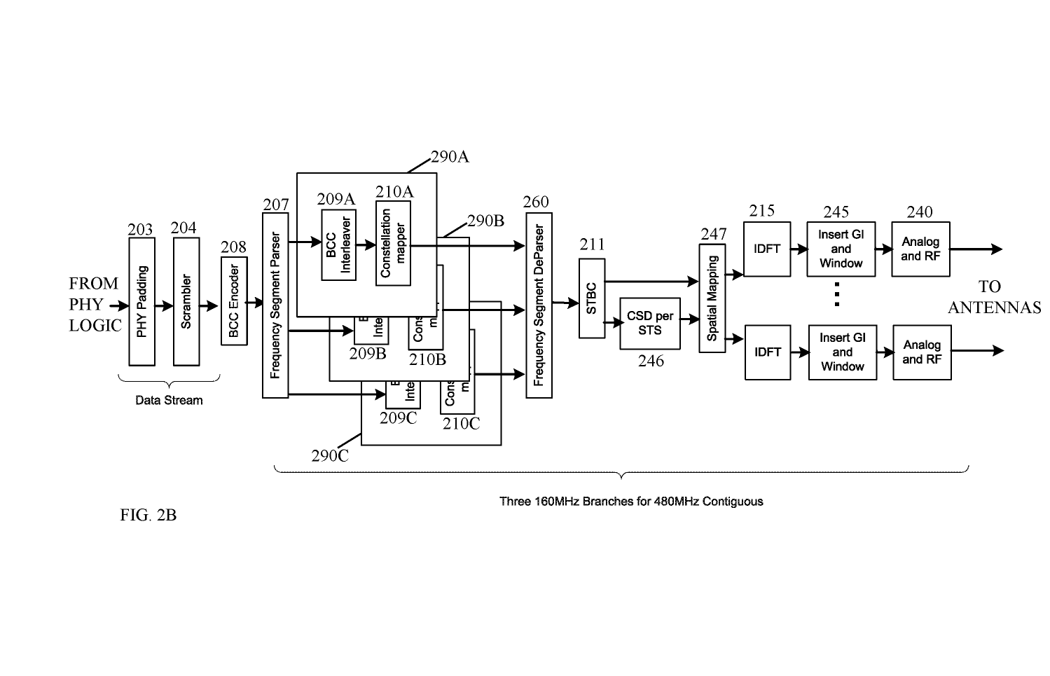

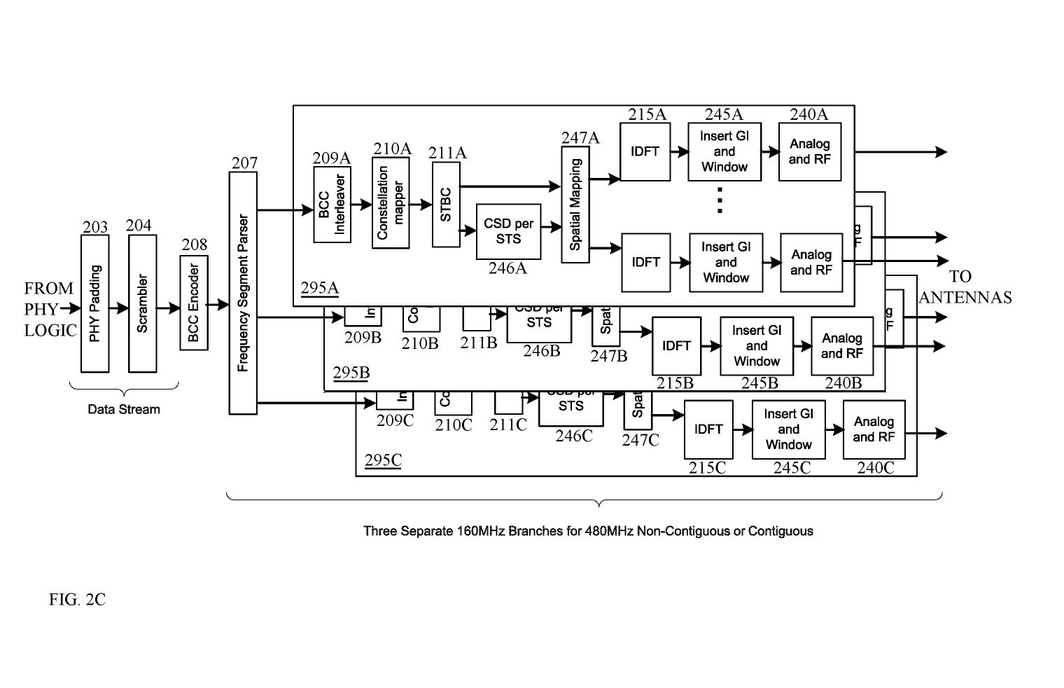

FIG. 2A depicts an embodiment of an apparatus to generate, transmit, receive, and interpret or decode MAC frames. The apparatus comprises a transceiver 200 coupled with Medium Access Control (MAC) sublayer logic 201 and a physical layer (PHY) logic 202. The MAC sublayer logic 201 may determine a frame and the physical layer (PHY) logic 202 may determine the PPDU by prepending the frame or multiple frames, also called MAC protocol data units (MPDUs), with a preamble to transmit via transceiver 200. For example, a frame builder may generate a frame including a type field that specifies the type of the frame such as a management, control, or data frame. A control frame may include a Ready-To-Send or Clear-To-Send frame. A management frame may comprise a Beacon, Probe Request/Response, Association Request/Response, and Reassociation Request/Response frame type. And the data type frame is designed to transmit data.

The transceiver 200 comprises a receiver 204 and a transmitter 206. The transmitter 206 may comprise one or more of an encoder 208, a frequency segment parser 207, an interleaver 209, a modulator 210, optionally a frequency segment deparser 260, an OFDM 212, an IFFT 215, a GI 245, and a transmitter front end 240. The encoder 208 of transmitter 206 receives and encodes a data stream destined for transmission from the MAC sublayer logic 202 with, e.g., a binary convolutional coding (BCC), a low density parity check coding (LDPC), and/or the like. The frequency segment parser 207 may receive data stream from encoder 208 and parse the data stream into two or more frequency segments to build a contiguous or non-contiguous bandwidth based upon building blocks of frequency segments that have smaller bandwidths. For instance, the frequency segment parser 207 may separate the data stream into three frequency segments including two frequency segments with 160 MHz bandwidths and one frequency segment with an 80 MHz bandwidth. The interleaver 209 may have three separate data processing paths to interleave the three frequency segments separately to prevent long sequences of adjacent noisy bits from entering a BCC decoder of a receiver.

The modulator 210 may receive the three data streams from interleaver 209 and may impress the received data blocks onto a sinusoid of a selected frequency for each stream via, e.g., mapping the data blocks into a corresponding set of discrete amplitudes of the sinusoid, or a set of discrete phases of the sinusoid, or a set of discrete frequency shifts relative to the frequency of the sinusoid. In some embodiments, the output of modulator 209 may be fed into the optional frequency segment deparser 260. In these embodiments, the transmitter 206 may be configured to transmit the, e.g., three frequency segments in a single, contiguous frequency bandwidth of, e.g., 400 MHz. Other embodiments may continue to process the three frequency segments as three separate data streams.

After the modulator 210, the data stream(s) are fed to an orthogonal frequency division multiplexing (OFDM) module 212. The OFDM module 212 may comprise a space-time block coding (STBC) module 211, and a digital beamforming (DBF) module 214. The STBC module 211 may receive constellation points from the modulator 209 corresponding to one or more spatial streams and may spread the spatial streams to a greater number of space-time streams (also generally referred to as data streams). Further embodiments may omit the STBC.

The OFDM module 212 impresses or maps the modulated data formed as OFDM symbols onto a plurality of orthogonal subcarriers so the OFDM symbols are encoded with the subcarriers or tones. In some embodiments, the OFDM symbols are fed to the Digital Beam Forming (DBF) module 214. Generally, digital beam forming uses digital signal processing algorithms that operate on the signals received by, and transmitted from, an array of antenna elements.

The Inverse Fast Fourier Transform (IFFT) module 215 may perform an inverse discrete Fourier transform (IDFT) on the OFDM symbols to map the subcarriers to each of the, e.g., three contiguous or non-contiguous frequency bandwidths. The output of the IFFT module 215 may enter the guard interval (GI) module 245. The GI module 245 may insert guard intervals by prepending to the symbol a circular extension of itself. In some embodiments, the GI module 245 may also comprise windowing to optionally smooth the edges of each symbol to increase spectral decay.

The output of the GI module 245 may enter the transmitter front end 240. The transmitter front end 240 may comprise a radio 242 with a power amplifier (PA) 244 to amplify the signal and prepare the signal for transmission via the antenna array 218.

In one embodiment, the radio 242, 252 may include a component or combination of components adapted for transmitting and/or receiving single carrier or multi-carrier modulated signals (e.g., including complementary code keying (CCK) and/or orthogonal frequency division multiplexing (OFDM) symbols) although the embodiments are not limited to any specific over-the-air interface or modulation scheme. The radio 242, 252 may include, for example, a receiver, a transmitter and/or a frequency synthesizer. The radio 242, 252 may include, for instance, bias controls, and a crystal oscillator, and may couple with one or more antennas 218. In another embodiment, the radio 242 may use external voltage-controlled oscillators (VCOs), surface acoustic wave filters, intermediate frequency (IF) filters and/or RF filters, as desired. Due to the variety of potential RF interface designs an expansive description thereof is omitted.

The signal may be up-converted to a higher carrying frequency or may be performed integrally with up-conversion. Shifting the signal to a much higher frequency before transmission enables use of an antenna array of practical dimensions. That is, the higher the transmission frequency, the smaller the antenna can be. Thus, an up-converter multiplies the modulated waveform by a sinusoid to obtain a signal with a carrier frequency that is the sum of the central frequency of the waveform and the frequency of the sinusoid.

The transceiver 200 may also comprise duplexers 216 connected to antenna array 218. Thus, in this embodiment, a single antenna array is used for both transmission and reception. When transmitting, the signal passes through duplexers 216 and drives the antenna with the up-converted information-bearing signal. During transmission, the duplexers 216 prevent the signals to be transmitted from entering receiver 204. When receiving, information bearing signals received by the antenna array pass through duplexers 216 to deliver the signal from the antenna array to receiver 204. The duplexers 216 then prevent the received signals from entering transmitter 206. Thus, duplexers 216 operate as switches to alternately connect the antenna array elements to the receiver 204 and the transmitter 206.

The antenna array 218 radiates the information bearing signals into a time-varying, spatial distribution of electromagnetic energy that can be received by an antenna of a receiver. The receiver can then extract the information of the received signal. In other embodiments, the transceiver 200 may comprise one or more antennas rather than antenna arrays and, in several embodiments, the receiver 204 and the transmitter 206 may comprise their own antennas or antenna arrays.

The transceiver 200 may comprise a receiver 204 for receiving, demodulating, and decoding information bearing communication signals. The receiver 204 may comprise a receiver front-end to detect the signal, detect the start of the packet, remove the carrier frequency, and amplify the subcarriers via a radio 252 with a low noise amplifier (LNA) 254. The receiver 204 may comprise a GI module 255 and a fast Fourier transform (FFT) module 219. The GI module 255 may remove the guard intervals and the windowing and the FFT module 219 may transform the communication signals from the time domain to the frequency domain.

The receiver 204 may also comprise an OFDM module 222, an optional frequency segment parser 262, a demodulator 224, a deinterleaver 225, a frequency segment deparser 227, and a decoder 226. An equalizer may output the weighted data signals for the OFDM packet to the OFDM module 222. The OFDM 222 extracts signal information as OFDM symbols from the plurality of subcarriers onto which information-bearing communication signals are modulated.

The OFDM module 222 may comprise a DBF module 220, and an STBC module 221. The received signals are fed from the equalizer to the DBF module 220. The DBF module 220 may comprise algorithms to process the received signals as a directional transmission directed toward to the receiver 204. And the STBC module 221 may transform the data streams from the space-time streams to spatial streams.

The output of the STBC module 221 may enter a frequency segment parser 262 if the communication signal is received as a single, contiguous bandwidth signal to parse the signal into, e.g., two or more frequency segments for demodulation and deinterleaving. On the other hand, if the communication is received as three separate bandwidth signals then the signals may be demodulated and deinterleaved prior to deparsing the signals.

The demodulator 224 demodulates the spatial streams. Demodulation is the process of extracting data from the spatial streams to produce demodulated spatial streams. The method of demodulation depends on the method by which the information is modulated onto the received carrier signal and such information is included in the transmission vector (TXVECTOR) included in the communication signal. Thus, for example, if the modulation is BPSK, demodulation involves phase detection to convert phase information to a binary sequence. Demodulation provides to the deinterleaver 225 a sequence of bits of information.

The deinterleaver 225 may deinterleave the sequence of bits of information. For instance, the deinterleaver 225 may store the sequence of bits in columns in memory and remove or output the bits from the memory in rows to deinterleave the bits of information. In many embodiments, the frequency segment deparser 227 may deparse the frequency segments as received if received as separate frequency segment signals, or may deparse the frequency segments determined by the optional frequency segment parser 262. The decoder 226 decodes the deparsed and deinterleaved data from the demodulator 224 and transmits the decoded information, the MPDU, to the MAC sublayer logic 202.

Persons of skill in the art will recognize that a transceiver may comprise numerous additional functions not shown in FIG. 2 and that the receiver 204 and transmitter 206 can be distinct devices rather than being packaged as one transceiver. For instance, embodiments of a transceiver may comprise a Dynamic Random Access Memory (DRAM), a reference oscillator, filtering circuitry, synchronization circuitry, an interleaver and a deinterleaver, possibly multiple frequency conversion stages and multiple amplification stages, etc. Further, some of the functions shown in FIG. 2 may be integrated. For example, digital beam forming may be integrated with orthogonal frequency division multiplexing.

The MAC sublayer logic 201 may parse the MPDU based upon a format defined in the communications device for a frame to determine the particular type of frame by determining the type value and the subtype value. The MAC sublayer logic 201 may then parse and interpret the remainder of MPDU based upon the definition for the frame of the particular type and subtype indicated in the MAC header.

FIG. 2B depicts an embodiment of a 480 MHz contiguous bandwidth transmitter such as the transmitter in FIG. 2A generated from three 160 MHz building blocks from a 160 MHz bandwidth IEEE 802.11ac communication signal. Reusing the building blocks in FIG. 2A creates a contiguous 480 MHz bandwidth system. The contiguous 480 MHz bandwidth system comprises adding the appropriate PHY padding bits by PHY padding 203 to the input PHY data stream to have an integer number of modulated symbols in each OFDM symbol. A scrambler 204 may scrambles the data to reduce the probability of long sequences of zeros or ones.

In the present embodiment, the data stream feeds to the BCC encoder 208. In other embodiments, the data stream may feed to a LDPC decoder.

A frequency segment parser 207 may feed the encoded bits of the data stream to each of the frequency segments (also referred to as blocks or subbands) 290A, 290B, and 290C. The BCC interleaver 209A-C may reuse the dimensional parameters outlined in the IEEE 802.11ac specification for the 80/160 MHz configuration. Additionally, and not obvious in this block diagram, the subcarrier allocation may be implemented as defined in IEEE 802.11ac. Thus, for each 160 MHz segment of the 480 MHz bandwidth the number of data, pilot, guard and nulling sub-carriers would be the same. In this 480 MHz the IDFT processes a block of three 160 MHz subcarriers. For the 160 MHz bandwidth signal there are a total of 468 data subcarriers and 16 pilot subcarriers specified in IEEE 802.11ac. Thus in this example with three—160 MHz subbands to create a contiguous 480 MHz, there are a total of 1404 data subcarriers in addition to 48 pilot subcarriers. In the contiguous case the subcarriers are mapped to each of the three 160 MHz subbands comprising a total 480 MHz bandwidth using a mapping function to the inverse discrete Fourier transform (IDFT) 215.

After interleaving the bits of the data streams in each of the three frequency segments 290A-C, the constellation mapper 210A-C may map each of the data streams separately to constellations to modulate the streams. The frequency segment deparser 260 may deparse or combine the streams into a data stream associated with subcarriers to transmit a single contiguous 480 MHz bandwidth communication signal.

In some embodiments, the Space time block code (STBC) 211 may spread constellation points from spatial streams into space time streams and the cyclic shift diversity per space time stream (CSD per STS) module 246 may insert cyclic shifts either before or after the IDFT 215 or as part of the spatial mapping module 247 to prevent unintentional beamforming.

In several embodiments, the spatial mapping module 247 may map space-time streams to transmit chains. Spatial mapping may involve direct mapping, spatial expansion vectors, or beamforming. In beamforming, for example, each vector of constellation points from all the space time streams is multiplied by a matrix of steering vectors to produce the input to the transmit chains.

The Inverse Discrete Fourier Transform (IDFT) module 215 may perform an inverse Fast Fourier transform (IFFT) on the OFDM symbols to map the subcarriers to the contiguous frequency bandwidth. The guard interval (GI) module 245 may insert guard intervals and windowing to optionally smooth the edges of each symbol to increase spectral decay.

The output of the GI module 245 may enter the transmitter front end (analog and RF) 240 to amplify the signal and prepare the signal for transmission via one or more antennas or an antenna array.

FIG. 2C depicts an embodiment of a 480 MHz non-contiguous or contiguous bandwidth transmitter such as the transmitter in FIG. 2A. The differences between this transmitter for non-contiguous or contiguous frequency bandwidth transmissions is that the frequency segment parser 207 parses or divides the data stream into three frequency segments 295A, 295B, and 295C but there is no corresponding frequency segment deparser prior to transmission so the three frequency segments are transmitted via three separate communications signals. Each of the processing modules from FIGS. 2A and 2B are shown in the frequency segments 295A-C with corresponding numbers such as 209A-C to indicate that there processing is the same but each operates on its own data stream in the corresponding frequency segment 295A-C.

In the present embodiment, the three frequency segments 295A-C may be generated for contiguous bandwidths or may be generated for non-contiguous bandwidths so the receiver may receive the transmission as either three separate bandwidth transmissions or a single, large bandwidth transmission of 480 MHz. Note that while the carrier frequencies for these embodiments may be, e.g., 5 GHz, 6-10 GHz, the carrier frequency can be any other frequency that can provide a large contiguous or non-contiguous bandwidth that is, e.g., greater than 160 MHz.

Although FIG. 2C shows the analog processing 240A-C in each chain separately, that is not a necessary element of the system. The analog processing can be done completely in each frequency segment, or partially in each frequency, or separately from the frequency segments 295A-C. In some embodiments, the analog processing could be done in a separate processing block that sums all the frequency signals and then does all the processing through to the antenna(s). For this system, the number of data and pilot sub-carriers is the same as in the contiguous system of FIG. 2B.

As was the case for the contiguous system of FIG. 2B, the description of FIG. 2C focuses on a single spatial stream system for simplicity and is straightforward to extend this to multiple spatial streams. Also, this was developed for a 480 MHz system. Embodiments are not limited to 480 MHz bandwidth operation. For example, the 80 MHz and/or 160 MHz bandwidth blocks can be used to build a system with any multiple of 80 MHz or 160 MHz bandwidths such as 320 MHz, 480 MHz, etc.

In addition to extending this to multiple streams, embodiments may also include the use of multiple encoders to afford implementation flexibility. To achieve this, in many embodiments, the parallel encoders may be used in place of the single encoder in FIG. 2A. Basically, a stream of bits from the scrambler may be distributed to each of the parallel encoders via, e.g., an encoder parser and the separate encoders may connect to a stream parser like in IEEE 802.11ac.

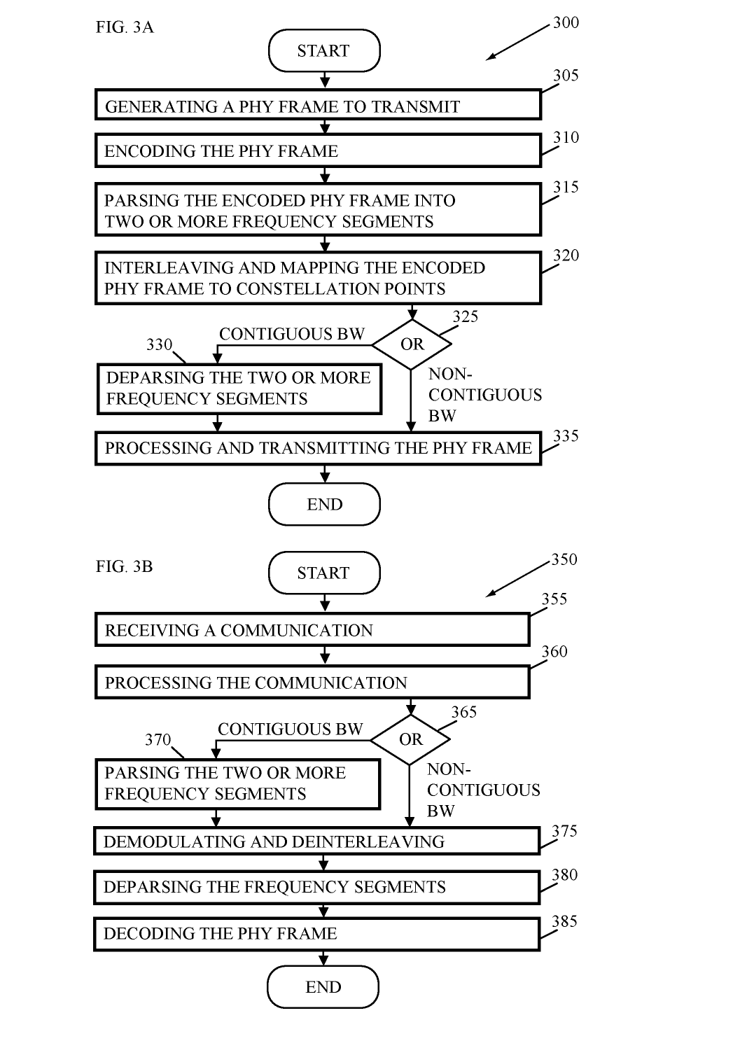

FIG. 3A-B depict embodiments of flowcharts to transmit a physical layer frame and to decode a physical layer frame. In particular, FIG. 3A depicts an embodiment of a flowchart 300 to process a physical layer frame for transmission. The flowchart 300 begins with a medium access control (MAC) sublayer determining a physical layer frame to transmit (element 305). In some embodiments, the MAC sublayer logic may determine a management frame such as a beacon and may transmit the MAC frame to the PHY layer device to transmit.

After determining the PHY frame to transmit, the PHY device may transmit the frame as a data stream through a series of processing modules to process the PHY frame for transmission. To prepare the data stream for processing, the data stream may be padded with bits to provide an integer number of modulated symbols in each OFDM symbol and scrambled to reduce the probability of long sequences of zeros or ones.

The PHY device may then encode the PHY frame (element 310) with, e.g., a Binary Convolutional Codes (BCC) and parse the encoded PHY frame to determine two or more frequency segments (element 315). For example, a transmitter may be designed to build a large bandwidth communication from a PHY frame by parsing the PHY frame into six frequency segments. Each frequency segment may be a fundamental building block for that receiver such as a 160 MHz bandwidth frequency segment. In some embodiments, all six segments may be used to generate the large bandwidth signal each time a PHY frame is transmitted. In other embodiments, the number of frequency segments, and thus the bandwidth of the transmission, may be dynamically selectable.

An interleaver and modulator may interleave and modulate the data streams in each of the frequency segments (element 320). In many embodiments, if the PHY device is designed for transmission of a contiguous bandwidth, the PHY device may include a frequency segment deparser after the modulator to combine the six frequency segments into a single data stream prior to transmission (element 330). In other embodiments (element 325), the PHY device may not include a frequency segment deparser. The PHY device may finish processing the PHY frame through the inverse discrete Fourier transform and other modules such as the modules in FIGS. 2A-C and transmit the PHY frame (element 335).

FIG. 3B depicts an embodiment of a flowchart 350 to receive, decode, parse and interpret, or otherwise determine a frame. The flowchart 350 begins with a PHY logic receiving a communication that includes the frame (element 355). The PHY logic may detect the communication by detection of an energy level at the receiver front end and, in response, begin processing the incoming OFDM packet. In some embodiments, the communication may include multiple non-contiguous bandwidth transmissions. In other embodiments, the communication may include a large contiguous bandwidth transmission such as a transmission with a bandwidth that is greater than 160 MHz.

After receiving the communication, the receiver may begin processing the transmission as, e.g., two or more non-contiguous bandwidth signals or one or two or more contiguous bandwidth transmissions (element 360). If the received transmission is a large contiguous bandwidth transmission (element 365), the receiver may parse the transmission into two or more frequency segments (element 370) and proceed to demodulating and deinterleaving the transmission (element 375). On the other hand, if the transmission is received as two or more non-contiguous transmissions, the receiver may proceed to demodulating and deinterleaving the transmission (element 375).

After demodulating and deinterleaving, the receiver may deparse the frequency segments to generate a single data stream with the combined data from the two or more frequency segments (element 380). The receiver may then decode the PHY frame (element 385), descramble the PHY frame, remove the bit padding, and transmit the payload of the PHY frame, if any, to the MAC logic to parse and interpret. Upon retrieving the value of the type subfield, the MAC sublayer logic may interpret the value by comparing the value to known values for the type subfield to identify the frame type.

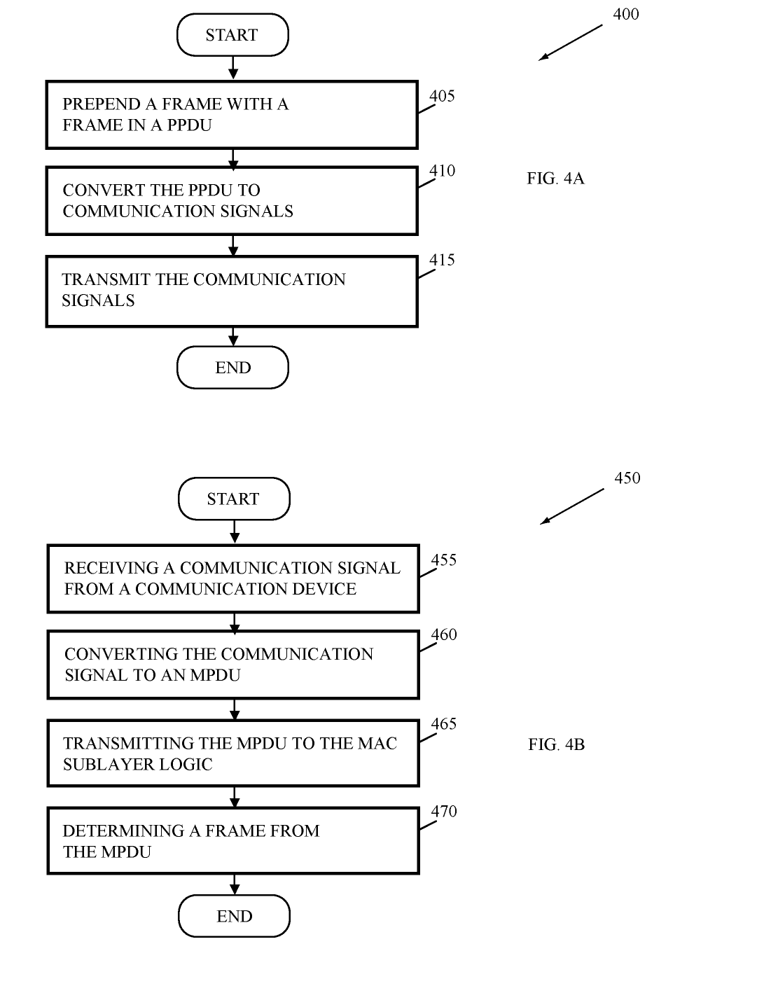

FIGS. 4A-B depict embodiments of flowcharts 400 and 450 to transmit, receive, and interpret communications with a frame. Referring to FIG. 4A, the flowchart 400 may begin with receiving a frame from the frame builder. The MAC sublayer logic of the communications device may generate the frame as a management frame to transmit to an access point and may pass the frame as an MAC protocol data unit (MPDU) to a data unit builder that transforms the data into a packet that can be transmitted to the access point. The data unit builder may generate a preamble to prepend the PHY service data unit (PSDU) (the MPDU from the frame builder) to form a PHY protocol data unit (PPDU) for transmission (element 405). In some embodiments, more than one MPDU may be prepended in a PPDU.

The PPDU may then be transmitted to the physical layer device such as the transmitter 206 in FIGS. 2A-C or the transceiver 1020, 1040 in FIG. 1 so the PPDU may be parsed into two or more frequency segments associated with contiguous or non-contiguous bandwidths and converted to communication signals (element 410). The transmitter may then transmit the communication signals via one or more antennas or an antenna array (element 415).

Referring to FIG. 4B, the flowchart 450 begins with a receiver of an access point such as the receiver 204 in FIG. 2 receiving a communication signal via one or more antenna(s) such as an antenna element of antenna array 218 (element 455). The receiver may deparse the frequency segments of the communications signal and may convert the communication signal into an MPDU in accordance with the process described in the preamble (element 460). More specifically, the received signal is fed from the one or more antennas to a DBF such as the DBF 220. The DBF processes the signal with spatial selectivity based on the direction of receipt. The output of the DBF is fed to OFDM such as the OFDM 222. In some embodiments, the output may first be fed into a frequency parser to parse the communication signal into two or more frequency segments.

The OFDM may extract signal information from the plurality of subcarriers in each of the frequency segments onto which information-bearing signals are modulated. Then, the demodulator such as the demodulator 224 demodulates the signal information via, e.g., BPSK, 16-QAM, 64-QAM, 256-QAM, QPSK, or SQPSK. The signal may be deinterleaved and the frequency segments may then be deparsed.

The decoder such as the decoder 226 may decode the signal information from the demodulator via, e.g., BCC or LDPC, to extract the MPDU (element 460) and transmit the MPDU to MAC sublayer logic such as MAC sublayer logic 202 (element 465).

The MAC sublayer logic may determine frame field values from the MPDU (element 470) the frame control field. For instance, the MAC sublayer logic may determine frame field values such as the ACK policy field value of the frame.

The following examples pertain to further embodiments. One example comprises an apparatus to process a physical layer frame for transmission. The apparatus may comprise a physical layer logic to determine a physical layer frame to transmit; and a physical layer device coupled with the physical layer logic to encode the physical layer frame; to parse the physical layer frame into two or more frequency segments, wherein the two or more frequency segments comprise 80 megahertz or 160 megahertz bandwidth frequency segments and the total bandwidth of the two or more frequency segments is greater than 160 megahertz; to process the physical layer frame after the parsing.

In some embodiments, the apparatus may further comprise a processor, a memory coupled with the processor, a radio coupled with the physical layer device, and one or more antennas coupled with the radio to transmit the physical layer frame. In some embodiments, the physical layer device further comprises a frequency segment deparser to deparse the physical layer frame prior to transmission of the physical layer frame. In some embodiments, the physical layer device further comprises a frequency segment deparser to combine the two or more frequency segments prior to space-time block coding of the physical layer frame. In some embodiments, the frequency segment parser is configured to determine an 80 megahertz or 160 megahertz frequency segment in accordance with Institute of Electrical and Electronic Engineers 802.11ac in 5 gigahertz or 6 gigahertz to 10 gigahertz frequency bands.

Another embodiment comprises a method to process a physical layer frame for transmission. The method may comprise determining a physical layer frame to transmit; encoding the physical layer frame; parsing the physical layer frame, after the encoding, into two or more frequency segments, wherein the two or more frequency segments comprise 80 megahertz or 160 megahertz bandwidth frequency segments and the total bandwidth of the two or more frequency segments is greater than 160 megahertz; and processing the physical layer frame after the parsing for transmission.

In some embodiments, the method may further comprise deparsing the physical layer frame prior to transmitting the physical layer frame. In some embodiments, the deparsing comprises combining the two or more frequency segments prior to space-time block coding of the physical layer frame. In some embodiments, parsing the physical layer frame comprises determining an 80 megahertz or 160 megahertz frequency segment in accordance with Institute of Electrical and Electronic Engineers 802.11ac in 5 gigahertz or 6 gigahertz to 10 gigahertz frequency bands.

Further embodiments may include a system to transmit a physical layer frame. The system may comprise a processor; a memory coupled with the processor; a physical layer logic to determine the physical layer frame to transmit; a physical layer device coupled with the physical layer logic to encode the physical layer frame; to parse the physical layer frame into two or more frequency segments, wherein the two or more frequency segments comprise 80 megahertz or 160 megahertz bandwidth frequency segments and a total bandwidth of the two or more frequency segments is greater than 160 megahertz; to process the physical layer frame after the parsing; a radio coupled with the physical layer device; and one or more antennas coupled with the radio to transmit the frame.

In some embodiments, the physical layer device further comprises a frequency segment deparser to deparse the physical layer frame prior to transmission of the physical layer frame. In some embodiments, the physical layer device further comprises a frequency segment deparser to combine the two or more frequency segments prior to space-time block coding of the physical layer frame. In some embodiments, the frequency segment parser is configured to determine an 80 megahertz or 160 megahertz frequency segment in accordance with Institute of Electrical and Electronic Engineers 802.11ac in 5 gigahertz or 6 gigahertz to 10 gigahertz frequency bands.

Another embodiment comprises an apparatus to process a communication. The apparatus may comprise a physical layer logic; and a physical layer device coupled with the physical layer logic to receive the communication; to process the communication; to deparse the communication from two or more frequency segments, wherein the two or more 80 megahertz or 160 megahertz bandwidth frequency segments that comprise a total bandwidth of greater than 160 megahertz; and to decode the communication.

In some embodiments, the apparatus may further comprise a processor, a memory coupled with the processor, a radio coupled with the physical layer device, and one or more antennas coupled with the radio to receive the communication. In some embodiments, the physical layer device further comprises a frequency segment parser to parse the communication prior to demodulating the communication into two or more frequency segments. In some embodiments, the frequency segment parser is configured to divide the communication into the two or more frequency segments, wherein a frequency segment is determined in accordance with Institute of Electrical and Electronic Engineers 802.11ac. In some embodiments, the frequency segment deparser is configured to combine the two or more 80 megahertz or 160 megahertz bandwidth frequency segments.

Further embodiments may include a system to process a communication. The system may comprise a processor; a memory coupled with the processor; a physical layer logic; a physical layer device coupled with the physical layer logic to receive the communication; to process the communication; to deparse the communication from two or more frequency segments, wherein the two or more 80 megahertz or 160 megahertz bandwidth frequency segments that comprise a total bandwidth of greater than 160 megahertz; and to decode the communication; a radio coupled with the communication; and one or more antennas coupled with the radio to transmit the communication.

In some embodiments, the physical layer device further comprises a frequency segment parser to parse the communication prior to demodulating the communication into two or more frequency segments. In some embodiments, the frequency segment parser is configured to divide the communication into the two or more frequency segments, wherein a frequency segment is determined in accordance with Institute of Electrical and Electronic Engineers 802.11ac. In some embodiments, the frequency segment deparser is configured to combine the two or more 80 megahertz or 160 megahertz bandwidth frequency segments.

Another embodiment comprises a method to process a communication. The method may comprise receiving the communication; processing the communication; deparsing the communication, prior to decoding the communication, from two or more 80 megahertz or 160 megahertz bandwidth frequency segments that comprise a total bandwidth of greater than 160 megahertz; and decoding the communication after the deparsing.

In some embodiments, the method may further comprise parsing the communication prior to demodulating the communication into two or more frequency segments. In some embodiments, the parsing comprises dividing the communication into the two or more frequency segments, wherein a frequency segment is determined in accordance with Institute of Electrical and Electronic Engineers 802.11ac. In some embodiments, deparsing the communication comprises combining the two or more 80 megahertz or 160 megahertz bandwidth frequency segments.

Further embodiments may include an apparatus to transmit a physical layer frame. The apparatus may comprise a means for determining a physical layer frame to transmit; a means for encoding the physical layer frame; a means for parsing the physical layer frame, after the encoding, into two or more frequency segments, wherein the two or more frequency segments comprise 80 megahertz or 160 megahertz bandwidth frequency segments and the total bandwidth of the two or more frequency segments is greater than 160 megahertz; and a means for processing the physical layer frame after the parsing for transmission.

In some embodiments, the apparatus may further comprise a means for deparsing the physical layer frame prior to transmitting the physical layer frame. In some embodiments, the means for deparsing comprises a means for combining the two or more frequency segments prior to space-time block coding of the physical layer frame. In some embodiments, the means for parsing the physical layer frame comprises a means for determining an 80 megahertz or 160 megahertz frequency segment in accordance with Institute of Electrical and Electronic Engineers 802.11ac in 5 gigahertz or 6 gigahertz to 10 gigahertz frequency bands.

Another embodiment comprises an apparatus to interpret a physical layer frame. The apparatus may comprise a means for receiving the communication; a means for processing the communication; a means for deparsing the communication, prior to decoding the communication, from two or more 80 megahertz or 160 megahertz bandwidth frequency segments that comprise a total bandwidth of greater than 160 megahertz; and a means for decoding the communication after the deparsing.

In some embodiments, the apparatus may further comprise a means for parsing the communication prior to demodulating the communication into two or more frequency segments. In some embodiments, the means for parsing comprises a means for dividing the communication into the two or more frequency segments, wherein a frequency segment is determined in accordance with Institute of Electrical and Electronic Engineers 802.11ac. In some embodiments, the means for deparsing the communication comprises a means for combining the two or more 80 megahertz or 160 megahertz bandwidth frequency segments.

In some embodiments, some or all of the features described above and in the claims may be implemented in one embodiment. For instance, alternative features may be implemented as alternatives in an embodiment along with logic or selectable preference to determine which alternative to implement. Some embodiments with features that are not mutually exclusive may also include logic or a selectable preference to activate or deactivate one or more of the features. For instance, some features may be selected at the time of manufacture by including or removing a circuit pathway or transistor. Further features may be selected at the time of deployment or after deployment via logic or a selectable preference such as a dipswitch or the like. A user after via a selectable preference such as a software preference, an e-fuse, or the like may select still further features.

A number of embodiments may have one or more advantageous effects. For instance, some embodiments may offer reduced MAC header sizes with respect to standard MAC header sizes. Further embodiments may include one or more advantageous effects such as smaller packet sizes for more efficient transmission, lower power consumption due to less data traffic on both the transmitter and receiver sides of communications, less traffic conflicts, less latency awaiting transmission or receipt of packets, and the like.

Another embodiment is implemented as a program product for implementing systems and methods described with reference to FIGS. 1-4. Some embodiments can take the form of an entirely hardware embodiment, an entirely software embodiment, or an embodiment containing both hardware and software elements. One embodiment is implemented in software, which includes but is not limited to firmware, resident software, microcode, etc.

Furthermore, embodiments can take the form of a computer program product (or machine-accessible product) accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device). Examples of a computer-readable medium include a semiconductor or solid-state memory, magnetic tape, a removable computer diskette, a random access memory (RAM), a read-only memory (ROM), a rigid magnetic disk, and an optical disk. Current examples of optical disks include compact disk-read only memory (CD-ROM), compact-read/write (CD-R/W), and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

The logic as described above may be part of the design for an integrated circuit chip. The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product.

What is claimed is:

1. An apparatus to process a physical layer frame for transmission, the apparatus comprising:
a physical layer logic to determine a physical layer frame to transmit; and
a physical layer device coupled with the physical layer logic to encode the physical layer frame; to parse the physical layer frame into two or more frequency segments, wherein the two or more frequency segments comprise 80 megahertz or 160 megahertz bandwidth frequency segments and the total bandwidth of the two or more frequency segments is greater than 160 megahertz; to process the physical layer frame after the parsing.

2. The apparatus of claim 1, further comprising a processor, a memory coupled with the processor, a radio coupled with the physical layer device, and one or more antennas coupled with the radio to transmit the physical layer frame.

3. The apparatus of claim 1, wherein the physical layer device further comprises a frequency segment deparser to deparse the physical layer frame prior to transmission of the physical layer frame.

4. The apparatus of claim 3, wherein the physical layer device further comprises a frequency segment deparser to combine the two or more frequency segments prior to space-time block coding of the physical layer frame.

5. The apparatus of claim 1, wherein the frequency segment parser is configured to determine an 80 megahertz or 160 megahertz frequency segment in accordance with Institute of Electrical and Electronic Engineers 802.11ac in 5 gigahertz or 6 gigahertz to 10 gigahertz frequency bands.

6. A method to process a physical layer frame for transmission, the method comprising:
determining a physical layer frame to transmit;
encoding the physical layer frame;
parsing the physical layer frame, after the encoding, into two or more frequency segments, wherein the two or more frequency segments comprise 80 megahertz or 160 megahertz bandwidth frequency segments and the total bandwidth of the two or more frequency segments is greater than 160 megahertz; and
processing the physical layer frame after the parsing for transmission.

7. The method of claim 6, further comprising deparsing the physical layer frame prior to transmitting the physical layer frame.

8. The method of claim 7, wherein the deparsing comprises combining the two or more frequency segments prior to space-time block coding of the physical layer frame.

9. The method of claim 6, wherein parsing the physical layer frame comprises determining an 80 megahertz or 160 megahertz frequency segment in accordance with Institute of Electrical and Electronic Engineers 802.11ac in 5 gigahertz or 6 gigahertz to 10 gigahertz frequency bands.

10. A system to transmit a physical layer frame, the system comprising:
a processor;
a memory coupled with the processor;
a physical layer logic to determine the physical layer frame to transmit;
a physical layer device coupled with the physical layer logic to encode the physical layer frame; to parse the physical layer frame into two or more frequency segments, wherein the two or more frequency segments comprise 80 megahertz or 160 megahertz bandwidth frequency segments and a total bandwidth of the two or more frequency segments is greater than 160 megahertz; to process the physical layer frame after the parsing;
a radio coupled with the physical layer device; and
one or more antennas coupled with the radio to transmit the frame.

11. The system of claim 10, wherein the physical layer device further comprises a frequency segment deparser to deparse the physical layer frame prior to transmission of the physical layer frame.

12. The system of claim 11, wherein the physical layer device further comprises a frequency segment deparser to combine the two or more frequency segments prior to space-time block coding of the physical layer frame.

13. The system of claim 10, wherein the frequency segment parser is configured to determine an 80 megahertz or 160 megahertz frequency segment in accordance with Institute of Electrical and Electronic Engineers 802.11ac in 5 gigahertz or 6 gigahertz to 10 gigahertz frequency bands.

14. An apparatus to process a communication, the apparatus comprising;
a physical layer logic; and
a physical layer device coupled with the physical layer logic to receive the communication; to process the communication; to deparse the communication from two or more frequency segments, wherein the two or more 80 megahertz or 160 megahertz bandwidth frequency segments that comprise a total bandwidth of greater than 160 megahertz; and to decode the communication.

15. The apparatus of claim 14, further comprising a processor, a memory coupled with the processor, a radio coupled with the physical layer device, and one or more antennas coupled with the radio to receive the communication.

16. The apparatus of claim 14 wherein the physical layer device further comprises a frequency segment parser to parse the communication prior to demodulating the communication into two or more frequency segments.

17. The apparatus of claim 16, wherein the frequency segment parser is configured to divide the communication into the two or more frequency segments, wherein a frequency segment is determined in accordance with Institute of Electrical and Electronic Engineers 802.11ac.

18. The apparatus of claim 14, wherein the frequency segment deparser is configured to combine the two or more 80 megahertz or 160 megahertz bandwidth frequency segments.

19. A system to process a communication comprising:
a processor;
a memory coupled with the processor;
a physical layer logic;
a physical layer device coupled with the physical layer logic to receive the communication; to process the communication; to deparse the communication from two or more frequency segments, wherein the two or more 80 megahertz or 160 megahertz bandwidth frequency segments that comprise a total bandwidth of greater than 160 megahertz; and to decode the communication;
a radio coupled with the communication; and
one or more antennas coupled with the radio to transmit the communication.

20. The system of claim 19, wherein the physical layer device further comprises a frequency segment parser to parse the communication prior to demodulating the communication into two or more frequency segments.

21. The system of claim 20, wherein the frequency segment parser is configured to divide the communication into the two or more frequency segments, wherein a frequency segment is determined in accordance with Institute of Electrical and Electronic Engineers 802.11ac.

22. The system of claim 19, wherein the frequency segment deparser is configured to combine the two or more 80 megahertz or 160 megahertz bandwidth frequency segments.

23. A method to process a communication, the method comprising:
receiving the communication;
processing the communication;
deparsing the communication, prior to decoding the communication, from two or more 80 megahertz or 160 megahertz bandwidth frequency segments that comprise a total bandwidth of greater than 160 megahertz; and
decoding the communication after the deparsing.

24. The method of claim 23, further comprising parsing the communication prior to demodulating the communication into two or more frequency segments.

25. The method of claim 23, wherein deparsing the communication comprises combining the two or more 80 megahertz or 160 megahertz bandwidth frequency segments.
